(19) United States
(12) Patent Application Publication
(10) Pub. No.: US 2023/0101160 A1
(43) Pub. Date: Mar. 30, 2023

(54) RUBBER COMPOSITION AND TIRE

(71) Applicant: The Goodyear Tire & Rubber Company, Akron, OH (US)

(72) Inventors: Marie-Laure Stephanie Milan, Strassen (LU); Jerome Joel Daniel Delville, Rehon (FR); Claude Charles Jacoby, Wasserbillig (LU); Carlo Kanz, Mamer (LU); Christian Jean-Marie Kaes, Schrondweiler (LU); Cecilia Aguiar Da Silva, Helmsange (LU)

(21) Appl. No.: 17/813,740

(22) Filed: Jul. 20, 2022

Related U.S. Application Data
(60) Provisional application No. 63/250,363, filed on Sep. 30, 2021.

(51) Int. Cl. C08F 236/06; C08F 212/08; C08F 136/08; C08K 5/01; C08K 3/36; C08K 3/22; C08C 19/20; C08C 19/22; C08C 19/25; B60C 1/00

(52) U.S. Cl. CPC C08F 236/06; C08F 212/08; C08F 136/08; C08K 5/01; C08K 3/36; C08K 3/22; C08C 19/20; C08C 19/22; C08C 19/25; B60C 1/0016; C08K 2201/003; C08K 2201/006; C08K 2003/2227

(57) ABSTRACT

The present invention is directed to a rubber composition comprising: 70 phr to 100 phr of at least one styrene butadiene rubber, 0 phr to 30 phr of at least one further diene-based rubber, from 40 phr to 200 phr of at least one filler, at least 5 phr of aluminum hydroxide, and at least 10 phr of at least one hydrocarbon resin selected from one or more of DCPD resins, CPD resins, and C5 resins. Furthermore, the present invention is directed to a tire comprising such a rubber composition.

### FIELD OF THE INVENTION

The present invention relates to a rubber composition. In particular, the rubber composition can be used in a tire, for instance in the tire tread.

### BACKGROUND OF THE INVENTION

In the development of summer tires, in particular of low rolling resistance summer tires, it is a challenge to further improve the balance between grip, including dry and/or wet grip, and rolling resistance. At the same time the tire should be robust.

While many improvements have been made in this area over the past decades, significant room for improving the balance of the above mentioned properties remains.

### SUMMARY OF THE INVENTION

One object of the present invention may be to provide an advanced rubber composition having an advantageous balance of improved grip and limited hysteresis.

Another object of the invention may be to provide an advanced rubber composition that has a sufficient tensile strength, good grip properties and limited hysteresis.

Yet another object of the invention may be to provide a rubber composition providing advanced wet and dry grip, at limited hysteresis (or rolling resistance respectively), optionally with a sufficient tensile strength.

The scope of protection of the present invention is defined by independent claim 1. Further preferred embodiments are provided in the dependent claims and the summary of the invention herein below.

Thus, in a first aspect of the invention, the present invention is directed to a rubber composition comprising 70 phr to 100 phr of at least one styrene butadiene rubber, 0 phr to 30 phr of at least one (further) diene-based rubber, from 40 phr to 200 phr of at least one filler, at least 5 phr of aluminum hydroxide, and at least 10 phr of at least one (hydrocarbon) resin selected from one or more of dicyclopentadiene (DCPD) resins, cyclopentadiene (CPD) resins, and C5 resins.

It has been found by the inventors that particularly the combination of aluminum hydroxide and the claimed resin types results in a surprisingly improved balance of rolling resistance and wet grip. Moreover, also tread wear can be further improved. Such a combination can be of particular interest for low rolling resistance tires, e.g. for low rolling resistance passenger car tires.

In one embodiment, the rubber composition comprises from 5 phr to 80 phr of the aluminum hydroxide, preferably from 10 phr to 40 phr of the aluminum hydroxide.

In another embodiment, the rubber composition comprises from 15 phr to 80 phr of the resin, preferably from 15 phr to 40 phr, or even more preferably from 15 phr to 35 phr of the resin.

In another embodiment, the resin is an at least partially hydrogenated resin, preferably a fully hydrogenated resin.

In still another embodiment, the resin is aromatically or C9 modified.

In yet another embodiment the resin is a hydrogenated and C9 modified resin, preferably a hydrogenated and C9 modified DCPD or CPD resin.

In another embodiment, the resin has a glass transition temperature within a range of 35° C. to 65° C. It is preferred in this embodiment that the resin has a relatively high but still limited glass transition temperature. A glass transition temperature of a resin is determined herein as a peak midpoint by a differential scanning calorimeter (DSC) at a temperature rate of increase of 10° C. per minute, according to ASTM D6604 or equivalent.

In another embodiment, the resin is selected from one or more of C5 resins, CPD resins, DCPD resins, C9 modified C5 resins, C9 modified CPD resins, and C9 modified DCPD resins. Optionally, these resins may be partially or fully hydrogenated.

In another embodiment, the resin is selected from one or more of C9 modified CPD and C9 modified DCPD resins.

In another embodiment, the resin has an aromatic proton content within a range of 5% to 15%, preferably within a range of 8% to 12%. This content may for instance be determined by NMR, as known by the person skilled in the art.

In another embodiment, the resin has a softening point within a range of 88° C. to 110° C., determined herein according to ASTM E28, or equivalent, which might sometimes be referred to as a ring and ball softening point.

In another embodiment, the resin has a weight average molecular weight Mw within a range of 500 g/mol to 800 g/mol, as determined by gel permeation chromatography (GPC) using polystyrene calibration standards according to ASTM 5296-11 or equivalent.

In another embodiment, the rubber composition has a glass transition temperature within a range of −25° C. to −15° C., determined as described herein below.

In another embodiment, the at least one styrene butadiene rubber is a solution polymerized styrene butadiene rubber; and/or wherein the diene-based rubber is a polyisoprene, preferably one or more of synthetic polyisoprene and natural rubber.

In still another embodiment, the rubber composition comprises i) a first styrene butadiene rubber (preferably solution polymerized) having a glass transition temperature within a range of −51° C. to −86° C., and ii) a second styrene butadiene rubber (preferably solution polymerized) having a glass transition temperature within a range of −10° C. to −45° C. Preferably, at least one (or both) of said first and second styrene butadiene rubbers is functionalized for the coupling to the filler (such as to carbon black or to silica), in particular to the silica.

In yet another embodiment, the rubber composition comprises from 40 phr to 60 phr of the first styrene butadiene rubber and from 30 phr to 50 phr of the second styrene butadiene rubber.

In still another embodiment, the first and the second styrene butadiene rubbers comprise at least one functional group configured for the coupling to the silica.

In still another embodiment, at least one of the first and the second styrene butadiene rubbers comprise at least one functional group configured for the coupling to the silica, and wherein said functional group is selected from one or more of siloxy, alkoxy, amino, alkylsiloxy, tin amino, amino siloxane, and amino silane and thiol groups.

In still another embodiment, one styrene butadiene rubber of the first and the second styrene butadiene rubbers is functionalized with an amino silane group and another one of the first and the second styrene butadiene rubbers is functionalized with an amino siloxane group.

In still another embodiment, one of the first and second styrene butadiene rubbers is functionalized with at least one thiol group and another one of the first and second styrene butadiene rubbers is functionalized with at least one of an amino silane or amino siloxane group. Preferably, the styrene butadiene rubber having the lower Tg is functionalized with the thiol group.

In yet another embodiment, the first styrene butadiene rubber has a glass transition temperature within a range of −20° C. to −35° C. and the second styrene butadiene rubber has a glass transition temperature within a range of −55° C. to −69° C.

In yet another embodiment, the filler is comprised predominantly of silica.

In yet another embodiment, the filler comprises less than 10 phr of carbon black, preferably less than 5 phr of carbon black, and at least 40 phr of silica.

In still another embodiment, the rubber composition comprises at most 85 phr of silica. A limited silica or filler amount is in particular desired for low rolling resistance applications or even ultra low rolling resistance applications.

In still another embodiment, the aluminum hydroxide has one or more of (i) a D50 particle diameter within a range of 0.2 μm and 5 μm, or (ii) a BET surface area within a range of 1 m²/g to 20 m²/g. The aluminum hydroxide particle diameters are determined with a Zetasizer™ Nano S from Malvern using dynamic light scattering based on ISO 22412 or equivalent. The BET surface area of aluminum hydroxide particles is determined in accordance with ISO 9277 or equivalent.

In still another embodiment, the silica has a BET surface area within a range of 150 m²/g and 220 m²/g. In particular, high surface area silicas are preferred herein.

In yet another embodiment, the rubber composition comprises one or more of (i) 0 phr to less than 5 phr of further resins apart from said hydrocarbon resin; and (ii) 0 phr to less than 5 phr of oil. Thus, in such a preferred embodiment, the amounts of further plasticizers and/or resins or oils are limited. Preferably, the oil content is less than 1 phr or 0 phr.

In particular, said rubber may be functionalized (preferably end functionalized) with a group comprising at least one thiol group and at least one alkoxy group.

In yet another embodiment, the rubber composition comprises from 1 phr to 4 phr of a vegetable oil having a glass transition temperature within a range of −75° C. to −100° C., preferably within a range of −75° C. to −90° C. The glass transition temperature of an oil is determined as a peak midpoint by a differential scanning calorimeter (DSC) at a temperature rate of increase of 10° C. per minute, according to ASTM E1356 or equivalent.

In still another embodiment, the rubber composition comprises predominantly silica as a filler, wherein the composition further comprises a mercapto silane (preferably a blocked mercapto silane, such as 3-(octanoylthio)-1-propyltriethoxysilane) within a range of 1 phr to 20 phr, preferably from 2 phr to 10 phr.

In still another embodiment, the rubber composition further comprises an α,ω-bis(N,N′-dihydrocarbylthiocarbamamoyldithio)alkane, preferably within a range of 0.5 phr to 5 phr, or even more preferably from 1 phr to 4 phr.

In yet another embodiment, the α,ω-bis(N,N′-dihydrocarbylthiocarbamamoyldithio)alkane is selected from the group consisting of 1,2-bis(N,N′-dibenzylthiocarbamoyl-dithio)ethane; 1,3-bis(N,N′-dibenzylthiocarbamoyldithio)propane; 1,4-bis(N,N′-dibenzylth-iocarbamoyldithio)butane; 1,5-bis(N,N′-dibenzylthiocarbamoyl-dithio)pentane; 1,6-bis(N,N′-dibenzylthiocarbamoyldithio)hexane; 1,7-bis(N,N′-dibenzylth-iocarbamoyldithio)heptane; 1,8-bis(N,N′-dibenzylthiocarbamoyl-dithio)octane; 1,9-bis(N,N′-dibenzylthiocarbamoyldithio)nonane; and 1,10-bis(N,N′-dibenzylthiocarbamoyldithio)decane. Preferably, the α,ω-bis(N,N′-dihydrocarbylthiocarbamamoyldithio)alkane is 1,6-bis(N,N′-dibenzylthiocarbamoyldithio)hexane.

In another embodiment, the rubber composition comprises from 0.5 phr to 15 phr, preferably from 0.5 to 10 phr, or more preferably from 1 phr to 9 phr, or even more preferably from 1 phr to 5 phr of a rosin based resin. In particular, the inventors have found that even surprisingly small amounts of the rosin based resin can significantly support improved wet grip and/or wet handling performance. Using such small amounts of rosin is also positive from a costs perspective.

In another embodiment, the rosin based resin (or rosin acid based resin) is based on one or more of gum rosin and dimerized gum rosin.

In another embodiment, the rosin based resin has a softening point within a range of 70° C. to 160° C. A softening point of a resin is determined herein according to ASTM E28, or equivalent, which might sometimes be referred to as a ring and ball softening point.

In another embodiment, the rosin based resin has an acid number within a range of 130 to 180.

In another embodiment, the rosin based resin is a gum rosin, which has optionally a softening point within a range of 65° C. to 90° C., preferably from 70° C. to 85° C., and has preferably an acid number within a range of 140 to 180.

In yet another embodiment, the rosin based resin is a dimerized gum rosin, optionally having a softening point within a range of 130° C. to 160° C., preferably from 140° C. to 150° C., and has preferably an acid number within a range of 130 to 160 and even more preferably from 140 to 150.

In still another embodiment, the rosin based resin is predominantly comprised of abietic acid. In case it is dimerized, it is predominantly comprised of dimerized abietic acid.

In another embodiment, the rosin based resin is predominantly based on abietic acid.

Optionally, the term rosin based resin can be replaced by rosin or rosin resin.

In still another embodiment, the rubber composition comprises from 20 phr to 80 phr of a traction resin (or a hydrocarbon resin).

In another embodiment, the rubber composition may include at least one and/or one additional diene-based rubber. Representative synthetic polymers may be the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter may be acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g. acrolein, methyl isopropenyl ketone and vinylethyl ether. Specific examples of synthetic rubbers include neoprene (polychloroprene), polybutadiene (including cis 1,4-polybutadiene), polyisoprene (including cis 1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. Preferred rubber or elastomers may be in general natural rubber, synthetic polyisoprene, polybutadiene and SBR including SSBR.

In a preferred embodiment, the composition comprises less than 5 phr of natural rubber and/or polyisoprene or is essentially free/free of natural rubber and/or polyisoprene.

In an embodiment, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers, and emulsion polymerization prepared butadiene/acrylonitrile copolymers.

In another embodiment, an emulsion polymerization derived styrene-butadiene rubber (ESBR) might be used having a styrene content of 20 to 28 percent bound styrene or, for some applications, an ESBR having a medium to relatively high bound styrene content, namely, a bound styrene content of 30 to 45 percent. In many cases the ESBR will have a bound styrene content which is within the range of 26 to 31 percent. By emulsion polymerization prepared ESBR, it may be meant that styrene and 1,3-butadiene are copolymerized as an aqueous emulsion. Such are well known to those skilled in such art. The bound styrene content can vary, for example, from 5 to 50 percent. In one aspect, the ESBR may also contain acrylonitrile to form a terpolymer rubber, as ESBAR, in amounts, for example, of 2 to 30 weight percent bound acrylonitrile in the terpolymer. Emulsion polymerization prepared styrene/butadiene/acrylonitrile copolymer rubbers containing 2 to 40 weight percent bound acrylonitrile in the copolymer may also be contemplated as diene-based rubbers.

In another embodiment, solution polymerization prepared SBR (SSBR) is used. Such an SSBR may for instance have a bound styrene content in a range of 5 to 50 percent, preferably 9 to 36 percent, and most preferably 26 to 31 percent. The SSBR can be conveniently prepared, for example, by anionic polymerization in an inert organic solvent. More specifically, the SSBR can be synthesized by copolymerizing styrene and a 1,3-butadiene monomer in a hydrocarbon solvent utilizing an organo lithium compound as the initiator. In still another embodiment, the solution styrene butadiene rubber is a tin-coupled polymer. In still another embodiment, the SSBR is functionalized for improved compatibility with silica. In addition, or alternatively, the SSBR is thio-functionalized. This helps to improve stiffness of the compound and/or its hysteresis behavior. Thus, for instance, the SSBR may be a thio-functionalized, tin-coupled solution polymerized copolymer of butadiene and styrene.

In one embodiment, a synthetic or natural polyisoprene rubber is used. Synthetic cis-1,4-polyisoprene and natural rubber are as such well known to those having skill in the rubber art. In particular, the cis 1,4-microstructure content may be at least 90% and is typically at least 95% or even higher.

In one embodiment, cis-1,4-polybutadiene rubber (BR or PBD) is used. Suitable polybutadiene rubbers may be prepared, for example, by organic solution polymerization of 1,3-butadiene. The BR may be conveniently characterized, for example, by having at least a 90 percent cis-1,4-microstructure content (“high cis” content) and a glass transition temperature (Tg) in a range of from −95 to −110° C. Suitable polybutadiene rubbers are available commercially, such as Budene® 1207, Budene® 1208, Budene® 1223, or Budene® 1280 from The Goodyear Tire & Rubber Company. These high cis-1,4-polybutadiene rubbers can for instance be synthesized utilizing nickel catalyst systems which include a mixture of (1) an organonickel compound, (2) an organoaluminum compound, and (3) a fluorine containing compound as described in U.S. Pat. Nos. 5,698,643 and 5,451,646, which are incorporated herein by reference.

A glass transition temperature, or Tg, of an elastomer or elastomer/rubber composition, where referred to herein, represents the glass transition temperature(s) of the respective elastomer or elastomer composition in its uncured state or possibly a cured state in the case of an elastomer composition. A Tg can be suitably determined by the midpoint or inflection point of the step observed in association with the glass transition, as measured using a differential scanning calorimeter (DSC) at a temperature change rate of 10° C. per minute, according to ASTM D3418.

The term “phr” as used herein, and according to conventional practice, refers to “parts by weight of a respective material per 100 parts by weight of rubber, or elastomer”. In general, using this convention, a rubber composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber. In an example, the composition may further comprise from 1 phr to 10 phr, optionally from 1 to 5 phr, of one or more additional diene-based rubbers, such as SBR, SSBR, ESBR, PBD/BR, NR and/or synthetic polyisoprene. In another example, the composition may include less than 5, preferably less than 3, phr of an additional diene-based rubber or be also essentially free of such an additional diene-based rubber. The terms “compound” and “composition” and “formulation” may be used herein interchangeably, unless indicated otherwise.

In an embodiment, the rubber composition may also include one or more additional oils, in particular (additional) processing oils. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils may include various oils as are known in the art, including aromatic, paraffinic, naphthenic, vegetable oils, and low PCA oils, such as MES, TDAE, SRAE and heavy naphthenic oils. Suitable low PCA oils may include those having a polycyclic aromatic (PCA) content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Some representative examples of (non-aminated and non-epoxidized) vegetable oils that can be used include soybean oil, sunflower oil, canola (rapeseed) oil, corn oil, coconut oil, cottonseed oil, olive oil, palm oil, peanut oil, and safflower oil.

In an embodiment, the rubber composition includes silica. Commonly employed siliceous pigments which may be used in the rubber compound include for instance conventional pyrogenic and precipitated siliceous pigments (silica). In one embodiment, precipitated silica is used. The conventional siliceous pigments may be precipitated silicas such as, for example, those obtained by the acidification of a soluble silicate, e.g., sodium silicate. Such conventional silicas might be characterized, for example, by having a BET surface area, as measured using nitrogen gas. In one embodiment, the BET surface area may be in the range of 40 to 600 square meters per gram. In another embodiment, the BET surface area may be in a range of 50 to 300 square meters per gram. The BET surface area is determined herein according to ASTM D5604-96 or equivalent. The conventional silica may also be characterized by having a dibutylphthalate (DBP) absorption value in a range of 100 cm³/100 g to 400 cm³/100 g, alternatively 150 cm³/100 g to 300 cm³/100 g which can be suitably determined according to ASTM D 2414 or equivalent. Various commercially available silicas may be used, such as, only for example herein, and without limitation, silicas commercially available from PPG Industries under the Hi-Sil trademark with designations 210, 315G, EZ160G, etc.; silicas available from Solvay, with, for example, designations ZeoSil 1165 MP and ZeoSil Premium 200 MP, etc.; and silicas available from Evonik AG with, for example, designations VN2 and Ultrasil 6000GR, 9100GR, etc.

In still another embodiment, the rubber composition may comprise pre-silanized and precipitated silica which may for instance have a CTAB adsorption surface area of between 130 m²/g and 210 m²/g, optionally between 130 m²/g and 150 m²/g and/or between 190 m²/g and 210 m²/g, or even between 195 m²/g and 205 m²/g. The CTAB (cetyl trimethyl ammonium bromide) method for determination of the silica surface area (ASTM D6845) is known to a person skilled in the art.

In another embodiment, surface-modified precipitated silica which is treated prior to its addition to the rubber composition with at least one silane or silazane is employed. Suitable surface modification agents include but are not limited to alkylsilanes, alkoxysilanes, organoalkoxysilyl polysulfides, organomercaptoalkoxysilanes, and hexamethyldisilazane.

Silica dispersing aids, which can optionally be used, can be present in an amount ranging from about 0.1% to about 25% by weight, based on the weight of the silica, with about 0.5% to about 20% by weight being suitable, and about 1% to about 15% by weight based on the weight of the silica also being suitable. Various pre-treated precipitated silicas are described in U.S. Pat. Nos. 4,704,414, 6,123,762 and 6,573,324. The teachings of U.S. Pat. Nos. 4,704,414, 6,123,762 and 6,573,324 are incorporated herein by reference.

Some non-limiting examples of pre-treated silicas (i.e. silicas that have been pre-surface treated with a silane) which are suitable for use in the practice of this invention include, but are not limited to, Ciptane® 255 LD and Ciptane® LP (PPG Industries) silicas that have been pre-treated with a mercaptosilane, and Coupsil® 8113 (Degussa) that is the product of the reaction between organosilane bis(triethoxysilylpropyl) polysulfide (Si69) and Ultrasil® VN3 silica, and Coupsil® 6508, Agilon® 400 silica from PPG Industries, Agilon® 454 silica from PPG Industries, and Agilon® 458 silica from PPG Industries. Some representative examples of preferred pre-silanized precipitated silicas include Agilon® 400, Agilon® 454 and Agilon® 458 from PPG Industries.

A representative silica coupler (silica coupling agent) having a moiety reactive with hydroxyl groups on pre-silanized precipitated silica and on precipitated silica and another moiety interactive with said elastomers, may be comprised of, for example: (A) bis(3-trialkoxysilylalkyl) polysulfide containing an average in range of from about 2 to about 4, alternatively from about 2 to about 2.6 or from about 3.2 to about 3.8, sulfur atoms in its connecting bridge, or (B) an alkoxyorganomercaptosilane, or (C) their combination. A representative example of such bis(3-trialkoxysilylalkyl) polysulfide is comprised of bis(3-triethoxysilylpropyl) polysulfide. As indicated, for the pre-silanized precipitated silica, the silica coupler may be desirably an alkoxyorganomercaptosilane. For the non-pre-silanized precipitated silica, the silica coupler may be desirably comprised of the bis(3-triethoxysilylpropyl) polysulfide.

In one embodiment, the rubber composition is exclusive of addition of silica coupler to the rubber composition (thereby exclusive of silica coupler).

As indicated, in one embodiment, the rubber composition may contain a combination of additional silica coupler added to the rubber composition, particularly a bis(3-triethoxysilylpropyl) polysulfide containing an average of from about 2 to about 4 connecting sulfur atoms in its polysulfidic bridge together with an additional precipitated silica (non-pre-silanized precipitated silica) added to said rubber composition, wherein the ratio of pre-silanized precipitated silica to said precipitated silica is desirably at least 8/1, alternately at least 10/1.

In an embodiment, the rubber composition may include carbon black. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991 grades. These carbon blacks have iodine absorptions ranging from 9 g/kg to 145 g/kg and a DBP number ranging from 34 cm³/100 g to 150 cm³/100 g. Iodine absorption values can be suitably determined according to ASTM D1510 or equivalent. Commonly employed carbon blacks can be used as a conventional filler in an amount ranging from 10 phr to 150 phr. However, in a preferred embodiment the composition comprises at most 10 phr of carbon black, preferably at most 5 phr of carbon black, as preferred embodiments are directed to high silica compounds and the improvement of their properties.

In another embodiment, other fillers may be used in the rubber composition including, but not limited to, particulate fillers including ultra high molecular weight polyethylene (UHMWPE), crosslinked particulate polymer gels including but not limited to those disclosed in U.S. Pat. Nos. 6,242,534, 6,207,757, 6,133,364, 6,372,857, 5,395,891, or 6,127,488, and a plasticized starch composite filler including but not limited to that disclosed in U.S. Pat. No. 5,672,639. The teachings of U.S. Pat. Nos. 6,242,534, 6,207,757, 6,133,364, 6,372,857, 5,395,891, 6,127,488, and 5,672,639 are incorporated herein by reference. Syndiotactic polybutadiene may also be utilized. Such other fillers may be used in an amount ranging from 1 phr to 30 phr.

In one embodiment, the rubber composition may contain a conventional sulfur containing organosilicon compounds or silanes. Examples of suitable sulfur containing organosilicon compounds are of the formula:

Z-Alk-Sn-Alk-Z I

in which Z is selected from the group consisting of

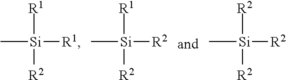

where R¹ is an alkyl group of 1 to 4 carbon atoms, cyclohexyl or phenyl; R² is an alkoxy of 1 to 8 carbon atoms, or cycloalkoxy of 5 to 8 carbon atoms; Alk is a divalent hydrocarbon of 1 to 18 carbon atoms and n is an integer of 2 to 8. In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide. Therefore, as to formula I, Z may be

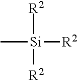

where R² is an alkoxy of 2 to 4 carbon atoms, alternatively 2 carbon atoms; Alk is a divalent hydrocarbon of 2 to 4 carbon atoms, alternatively of 3 carbon atoms; and n is an integer of from 2 to 5, alternatively 2 or 4. In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)_{3,} which is available commercially as NXT™ from Momentive Performance Materials. In another embodiment, suitable sulfur containing organosilicon compounds include those disclosed in United States Patent Application Publication No. 2003/0130535. In one embodiment, the sulfur containing organosilicon compound is Si-363 from Degussa. The amount of the sulfur containing organosilicon compound in a rubber composition may vary depending on the level of other additives that are used. Generally speaking, the amount of the compound may range from 0.5 phr to 20 phr. In one embodiment, the amount will range from 1 phr to 10 phr.

In another embodiment, the rubber composition comprises less than 0.1 phr cobalt salt or 0 phr cobalt salt.

It is readily understood by those having skill in the art that the rubber composition may be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants, antiozonants and peptizing agents. As known to those skilled in the art, depending on the intended use of the sulfur vulcanizable and sulfur-vulcanized material (rubbers), the additives mentioned above are selected and commonly used in conventional amounts. Some representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may for instance be used in an amount ranging from 0.5 phr to 8 phr, alternatively with a range of from 1.5 phr to 6 phr. Typical amounts of tackifier resins, if used, comprise for example 0.5 phr to 10 phr, usually 1 phr to 5 phr. Typical amounts of processing aids, if used, comprise for example 1 phr to 50 phr (this may comprise in particular oil). Typical amounts of antioxidants, if used, may for example comprise 1 phr to 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants, if used, may for instance comprise 1 phr to 5 phr. Typical amounts of fatty acids, if used, which can include stearic acid, may for instance comprise 0.5 phr to 3 phr. Typical amounts of waxes, if used, are typically employed at a level which is within the range of 1 phr to 5 phr. Often microcrystalline waxes are used. Typical amounts of peptizers, if used, are normally within the range of 0.1 phr to 1 phr. Typical peptizers may be, for example, pentachlorothiophenol and/or dibenzamidodiphenyl disulfide.

Accelerators may be preferably but not necessarily used to control the time and/or temperature required for vulcanization and to improve the properties of the vulcanizate. In one embodiment, a single accelerator system may be used, i.e. primary accelerator. The primary accelerator(s) may be used in total amounts ranging from 0.5 phr to 4 phr, alternatively 0.8 phr to 1.5 phr. In another embodiment, combinations of a primary and a secondary accelerator might be used with the secondary accelerator being used in smaller amounts, such as from 0.05 phr to 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are for instance amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be for instance a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

The mixing of the rubber composition can be accomplished by methods known to those having skill in the rubber mixing art. For example, the ingredients may be typically mixed in at least two stages, namely, at least one nonproductive stage followed by a productive mix stage. The final curatives including sulfur-vulcanizing agents may be typically mixed in the final stage which is conventionally called the “productive” mix stage in which the mixing typically occurs at a temperature, or ultimate temperature, lower than the mix temperature(s) of the preceding nonproductive mix stage(s). The terms “nonproductive” and “productive” mix stages are well known to those having skill in the rubber mixing art. In an embodiment, the rubber composition may be subjected to a thermomechanical mixing step. The thermomechanical mixing step generally comprises a mechanical working in a mixer or extruder for a period of time, for example suitable to produce a rubber temperature between 140° C. and 190° C. The appropriate duration of the thermomechanical working varies as a function of the operating conditions, and the volume and nature of the components. For example, the thermomechanical working may be from 1 to 20 minutes.

In yet a further aspect, the present invention is directed to a rubber product, the rubber product comprising a rubber composition in accordance with the above mentioned aspects or one or more of their embodiments.

In one embodiment, the rubber product is selected from a tire, a power transmission belt, a hose, a track, an air sleeve and a conveyor belt.

In another embodiment, the rubber product is a tire comprising one or more rubber components selected from a tread, a shearband, rubber spokes, an undertread, a sidewall, an apex, a flipper, a chipper, a chafer, a carcass, a belt, an overlay, wherein one or more of the rubber components comprise the rubber composition.

In another aspect of the invention a tire is provided, the tire comprising the rubber composition according to the first aspect of the invention and optionally in accordance with one or more of its embodiments.

In one embodiment the tire has a tread, comprising the rubber composition.

In another embodiment the tire has a tread with one or more tread cap layers, wherein the rubber composition is in one or more of the two radially outermost tread cap layers, preferably in the radially outermost tread cap layer.

In another embodiment, the rubber composition is in a tread cap layer radially inside of the radially outermost tread cap layer. The rubber composition is optionally not in the radially outermost tread cap layer. In such an embodiment a radially outermost tread cap layer does not comprise the rubber composition according to the invention. In contrast, the rubber composition of a tread cap layer radially below the radially outermost tread cap layer has the rubber composition according to the invention (or one or more of its embodiments). Such an arrangement or configuration can help to maintain the grip level, in particular wet grip at a similar level when the first tread cap layer is worn and radial rib or block heights of the tread have decreased. Then the loss of tread height can be at least partially compensated by the advanced grip of the rubber composition according to the present invention.

Vulcanization of the pneumatic tire of the present invention may for instance be carried out at conventional temperatures ranging from 100° C. to 200° C. In one embodiment, the vulcanization is conducted at temperatures ranging from 110° C. to 180° C. Any of the usual vulcanization processes may be used such as heating in a press or mold, heating with superheated steam or hot air. However, it is generally preferred for the tires of this invention to be cured at a temperature ranging from about 132° C. (270° F.) to about 166° C. (330° F.). It is more typical for the tires of this invention to be cured at a temperature ranging from 143° C. (290° F.) to 154° C. (310° F.).

Such tires can be built, shaped, molded and cured by various methods which are known and are readily apparent to those having skill in such art.

### BRIEF DESCRIPTION OF THE DRAWINGS

The structure, operation, and advantages of the invention will become more apparent upon contemplation of the following description taken in conjunction with the accompanying drawings, wherein

FIG. 1 is a schematic cross section of a tire comprising a rubber component with the rubber composition in accordance with an embodiment of the present invention.

### DETAILED DESCRIPTION OF THE INVENTION

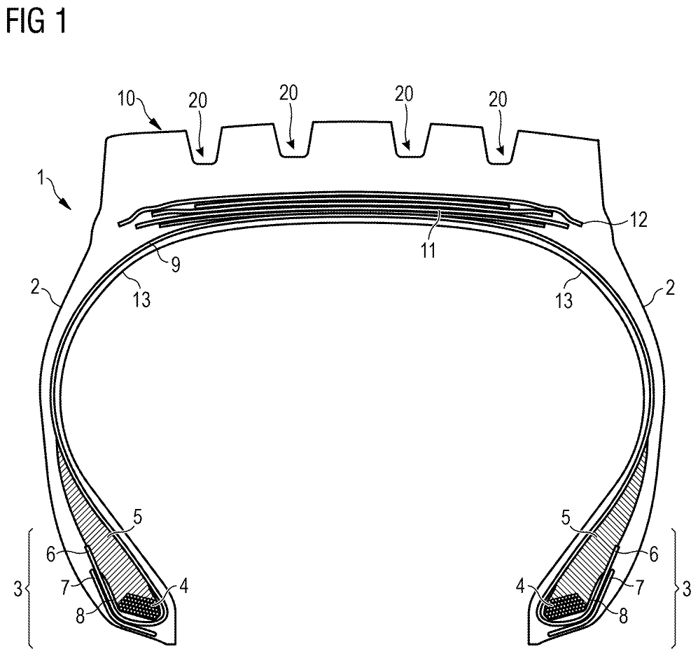

FIG. 1 is a schematic cross-section of a tire 1 according to an embodiment of the invention. The tire 1 has a plurality of tire components such as a tread 10, an innerliner 13, a belt comprising four belt plies 11, a carcass ply 9, two sidewalls 2, and two bead regions 3, bead filler apexes 5 and beads 4. The example tire 1 is suitable, for example, for mounting on a rim of a vehicle, e.g. a truck or a passenger car. As shown in FIG. 1, the belt plies 11 may be covered by an overlay ply 12 and/or may include one or more breaker plies. The carcass ply 9 includes a pair of axially opposite end portions 6, each of which is associated with a respective one of the beads 4. Each axial end portion 6 of the carcass ply 9 may be turned up and around the respective bead 4 to a position to anchor each axial end portion 6. The turned-up portions 6 of the carcass ply 9 may engage the axial outer surfaces of two flippers 8 and axial inner surfaces of two chippers 7 which are also considered as tire components. As shown in FIG. 1, the example tread 10 may have circumferential grooves 20, each groove 20 essentially defining a U-shaped opening in the tread 10. The main portion of the tread 10 may be formed of one or more tread compounds. Moreover, the grooves 20, in particular the bottoms and/or sidewalls of the grooves 20 could be reinforced by a rubber compound having a higher hardness and/or stiffness than the remaining tread compound. Such a reinforcement may be referred to herein as a groove reinforcement.

While the embodiment of FIG. 1 suggests a plurality of tire components including for instance apexes 5, chippers 7, flippers 8 and overlay 12, such and further components are not mandatory for the invention. Also, the turned-up end of the carcass ply 9 is not necessary for the invention or may pass on the opposite side of the bead area 3 and end on the axially inner side of the bead 4 instead of the axially outer side of the bead 4. The tire could also have for instance a different number of grooves 20, e.g. less than four grooves.

In an embodiment, the tread 10 of the tire 1 or of another tire comprises a rubber composition according to the Inventive Example as identified in Table 1 below. The rubber composition in accordance with a preferred embodiment of the invention is used in a tread or tread layer contacting the road.

TABLE 1

| | (phr) | |
|---|---|---|
| | Comparative | Inventive |
| Material | Example | Example |
| SSBR1¹ | 30 | 30 |
| SSBR2² | 50 | 50 |
| Polyisoprene³ | 20 | 20 |
| Resin 1⁴ | 22 | 0 |
| Resin 2⁵ | 0 | 22 |
| Aluminum hydroxide⁶ | 10 | 10 |
| Silica⁷ | 60 | 60 |
| Silane 1⁸ | 7.2 | 7.2 |
| Silane 2⁹ | 1 | 1 |
| Stearic Acid | 2.5 | 2.5 |
| Waxes | 2.3 | 2.3 |
| Zinc Oxide | 2 | 2 |
| Antidegradants¹⁰ | 6.3 | 6.3 |
| Sulfur | 1 | 1 |
| BDBzTH¹¹ | 2.2 | 2.2 |
| Further Curatives¹² | 3 | 3 |
| Carbon black | 1 | 1 |

¹as Sprintan ™ SLR 3402 from Trinseo, having a Tg of −62° C. and a thiol-alkoxysilane functionalization
²as HPR 355H from JSR, having a Tg of about −27° C. and an aminosilane functionalization
³natural rubber
⁴Dercolyte ™ A115 from DRT, having a Tg of about 70° C.
⁵as Oppera ™ 383 from Exxon Mobil, having Tg of about 54° C.
⁶Al(OH)₃ having a BET surface area of 15 m²/g, d50 of 0.4 μm, d90 of 0.8 μm, and d10 of 0.3 μm, and a material density of 2.4 g/cm³
⁷as Zeosil ™ Premium 200 MP from Solvay, having a BET surface area of 215 m²/g
⁸bis-triethoxysilylpropyl disulfide
⁹bis-triethoxysilylpropyl tetrasulfide
¹⁰based on dihydroquinolines and phenylenediamines
¹¹1,6-bis(N,N-dibenzylthiocarbamoyldithio)hexane as Vulcuren TM from the company Lanxess, including about 10% oil and carbon black
¹²TBBS and DPG types

Table 2 shows tire properties obtained on the basis of the Comparative Example and the Inventive Example listed above in Table 1. As apparent from the below results, wet grip and tread wear are surprisingly significantly improved for the Inventive Example, by change of the resin type. Moreover, wet grip stays flat so that the overall balance of these properties has been improved according to Inventive Example 1.

TABLE 2

| Property | Comparative Example | Inventive Example |
|---|---|---|
| Rolling resistance ^{a} | 100 | 107 |
| Wet handling ^{b} | 100 | 100 |
| Tread wear ^{c} | 100 | 107 |

^{a} Laboratory test, results in percent, normalized to the Comparative Example, based on dynamical mechanical analysis (DMA) of tangent delta shear response at 30° C.
^{b} Laboratory test, results in percent, normalized to the Comparative Example, based on the determination of a transmittable friction force on a linear friction tester
^{c} Laboratory test, results in percent, normalized to the Comparative Example, based on abrasion determined according to ASTM D5963

While certain representative embodiments and details have been shown for the purpose of illustrating the subject invention, it will be apparent to those skilled in this art that various changes and modifications can be made therein without departing from the scope of the subject invention.

What is claimed is:

1. A rubber composition comprising:
70 phr to 100 phr of at least one styrene butadiene rubber,
0 phr to 30 phr of at least one further diene-based rubber,
from 40 phr to 200 phr of at least one filler,
at least 5 phr of aluminum hydroxide, and
at least 10 phr of at least one hydrocarbon resin selected from one or more of DCPD resins, CPD resins, and C5 resins.

2. The rubber composition according to claim 1 wherein the rubber composition comprises from 5 phr to 80 phr of the aluminum hydroxide.

3. The rubber composition according to claim 1 wherein the rubber composition comprises from 15 phr to 80 phr of the hydrocarbon resin.

4. The rubber composition according to claim 1 wherein the hydrocarbon resin is a hydrogenated hydrocarbon resin.

5. The rubber composition according to claim 1 wherein the hydrocarbon resin is aromatically modified.

6. The rubber composition according to claim 1 wherein the resin has a glass transition temperature within a range of 35° C. to 65° C.

7. The rubber composition according to claim 1 wherein the at least one styrene butadiene rubber is a solution polymerized styrene butadiene rubber and wherein the diene-based rubber is one or more of synthetic polyisoprene and natural rubber.

8. The rubber composition according to claim 6 wherein the at least one styrene butadiene rubber comprises (i) a first styrene butadiene rubber having a glass transition temperature within a range of −51° C. to −86° C., and (ii) a second styrene butadiene rubber having a glass transition temperature within a range of −10° C. to −45° C.

9. The rubber composition according to claim 8 wherein at least one of said first and second styrene butadiene rubbers is functionalized for the coupling to silica.

10. The rubber composition according to claim 1 wherein the filler is comprised predominantly of silica.

11. The rubber composition according to claim 1 wherein the filler comprises less than 10 phr carbon black and at least 40 phr of silica.

12. The rubber composition according to claim 1 wherein the rubber composition comprises at most 85 phr of silica.

13. The rubber composition according to claim 1 wherein the aluminum hydroxide has one or more of (i) a D50 particle diameter within a range of 0.2 μm and 5 μm, or (ii) a BET surface area within a range of 1 m²/g to 20 m²/g.

14. The rubber composition according to claim 1 wherein the silica has a BET surface area within a range of 150 m²/g and 220 m²/g.

15. The rubber composition according to claim 1 which comprises one or more of (i) 0 phr to less than 5 phr of further resins apart from said hydrocarbon resin; and (ii) 0 phr to less than 5 phr of oil.

16. The rubber composition according to claim 6 wherein the resin has an aromaticity within a range of 8% to 12%.

17. The rubber composition according to claim 6 wherein the resin has a softening point within a range of 88° C. to 110° C.

18. The rubber composition according to claim 8 wherein one of the first and second styrene butadiene rubbers is functionalized with at least one thiol group and another one of the first and second styrene butadiene rubbers is functionalized with at least one of an amino silane or amino siloxane group.

19. A tire comprising the rubber composition according to claim 1.

20. The tire of claim 19 comprising a tread with a radially outermost tread cap layer comprising said rubber composition.
